(19) United States
(12) Patent Application Publication
(10) Pub. No.: US 2022/0297228 A1
(43) Pub. Date: Sep. 22, 2022

(54) ALIGNMENT UNIT, SENSOR MODULE COMPRISING SAME, AND LASER WORKING SYSTEM COMPRISING THE SENSOR MODULE

(71) Applicant: Precitec GmbH & Co. KG, Gaggenau (DE)

(72) Inventors: Matthias Strebel, Gaggenau (DE); Georg Spörl, Rheinstetten (DE)

(21) Appl. No.: 17/635,468

(22) PCT Filed: Jul. 21, 2020
(86) PCT No.: PCT/EP2020/070545

§ 371 Date: Feb. 15, 2022

(30) Foreign Application Priority Data
Aug. 16, 2019 (DE) 10 2019 122 047.5

(51) Int. Cl. B23K 26/03; B23K 26/046; G02B 19/00; G02B 27/14

(52) U.S. Cl. CPC B23K 26/032; B23K 26/046; G02B 19/0076; G02B 27/141; G02B 19/0009

(57) ABSTRACT

An alignment module coupling a sensor unit to a laser machining device for monitoring a laser machining process is provided. The module includes a first coupling device with a first optical input for a process radiation coupled out of the laser machining device and a coupling element for coupling to the machining device; a second coupling device with a first optical output and a coupling element for coupling to the sensor unit; a first adjustment module arranged between the first and second coupling devices and configured to tilt and/or displace the coupling devices with respect to one another; and a focusing optics between the first optical input and the first optical output, which is slidably disposed along the optical axis of the focusing optics. A sensor module monitoring a laser machining process is provided, which includes the alignment module. A laser machining system is also provided, including the sensor module.

### CROSS-REFERENCE TO RELATED APPLICATIONS

This application is the U.S. National Stage of PCT/EP2020/070545 filed Jul. 21, 2020, which claims priority to German Patent Application No. 102019122047.5 filed August 16, 2019, the content of both of which are incorporated herein by reference in their entirety.

### FIELD OF THE INVENTION

The present invention relates to an alignment module for coupling a sensor unit to a laser machining device for monitoring a laser machining process performed by the laser machining device and a sensor module for a laser machining system for monitoring a laser machining process performed by the laser machining system comprising such an alignment module. The present invention also relates to a laser machining system comprising such a sensor module.

### BACKGROUND OF THE INVENTION

In a laser machining system for machining a workpiece my means of a laser beam, the laser beam emerging from a laser light source or from an end of a laser optical fiber is focused or collimated onto the workpiece to be machined with the aid of a beam guiding and focusing optics. Machining may comprise laser cutting, soldering or welding, for example. The laser machining system may also be referred to as a laser machining equipment, or equipment for short. The laser machining system may comprise a laser machining device, for example a laser machining head such as a laser cutting head or a laser welding head. In particular when laser welding or soldering a workpiece, it is important to continuously monitor the welding or soldering process and to ensure the machining quality. A machining process is typically monitored by acquiring and evaluating various parameters of a process radiation, also called process beam, process light or process emissions. These include, for example, laser light scattered back or reflected back from a surface of the workpiece, plasma radiation created by the machining, process emissions in the infrared range of light such as thermal radiation, or process emissions in the visible range of light.

The signals are typically acquired by means of a sensor unit connected to the laser machining device. The process radiation is coupled into the sensor unit from the laser machining device. The sensor unit typically includes a number of detectors or sensors that detect various parameters of the process radiation and output them as a measurement signal.

In order to ensure optimal monitoring by the sensor unit, the sensor unit must be adjusted with a laser machining device before initial operation. The purpose of the adjustment is to adjust the sensor unit to the respective laser machining device. In particular, the sensor unit is adjusted or aligned to the orientation and focusing of the process radiation coupled out of the laser machining device in order to enable an optimal detection of the process radiation and thus an exact determination of the parameters. The adjustment is typically performed by individually adjusting each detector of the sensor unit to the process radiation. The adjustment is therefore very time-consuming and must also be carried out directly at the respective laser machining device.

Furthermore, it is desirable to compare the measurement signals output from a plurality of sensor units attached to different laser machining devices or to compare the measurement signals output from different sensor units attached to the same laser machining device in succession. The measurement signals are typically not comparable since there are always differences in the optical beam path between two sensor units, i.e. in the optical path of the process radiation, and/or differences in the electronic components used. Differences in the optical beam path may result from different transmission or reflection properties of the optical components used in the respective sensor units, such as lenses and mirrors, or from imaging errors in the optical components, for example color errors or focal position errors. Differences in the electronics may be caused, for example, by different sensitivities of the detectors used or, more generally, by manufacturing tolerances of the components used. The differences mentioned may result, for example, in measurement signal strengths of two sensor units being different. As a result, process monitoring or control, which is already set for a laser machining device, must in turn be set up anew for each sensor unit.

### SUMMARY OF THE INVENTION

It is an object of the invention to ensure reproducible monitoring of laser machining processes. Furthermore, it is an object of the invention to simplify the process of putting a sensor unit for a laser machining system into operation. It is also an object of the invention to simplify the adjustment of a sensor unit for a laser machining system.

The objects are achieved by the subject matter disclosed herein. Advantageous embodiments and developments are the subject matter are also disclosed.

According to an aspect of the present disclosure, an alignment unit for coupling a sensor unit to a laser machining device for monitoring a laser machining process is provided, the alignment module comprising: a first coupling device including a first optical input for a process radiation coupled out of the laser machining device and a coupling element for coupling to the laser machining device; a second coupling device including a first optical output and a coupling element for coupling to the sensor unit; a first adjustment module which is arranged between the first coupling device and the second coupling device and is configured to tilt the first coupling device and the second coupling device with respect to one another and/or to displace them with respect to one another in at least in one direction; and a focusing optics between the first optical input and the first optical output, which is slidably disposed along the optical axis of the focusing optics. An alignment module for coupling a sensor unit to a laser machining device for monitoring a laser machining process carried out by the laser machining device according to an aspect of the present disclosure comprises a first coupling device for coupling to the laser machining device, wherein the first coupling device includes a first optical input for a process radiation coupled out of the laser machining device; a second coupling device for coupling to the sensor unit, wherein the second coupling device includes a first optical output for the process radiation; and a first adjustment module, which is arranged between the first coupling device and the second coupling device and is configured to tilt the second coupling device relative to the first coupling device and/or to displace it in at least one direction perpendicular to a central axis of the first optical input. Preferably, a focusing optics arranged between the first optical input and the first optical output and displaceable along an optical axis of the focusing optics is further provided.

According to another aspect of the present disclosure, a sensor module for a laser machining system for monitoring a laser machining process is provided, said sensor module comprising: an alignment module described above; and a sensor unit including a coupling element coupled to the second coupling device of the alignment module, an optical input for the process radiation emerging from the alignment module, and at least one detector for detecting the process radiation. The alignment module is configured to align the process radiation entering the optical input of the first coupling device with the central axis of the optical input of the sensor unit. According to an aspect, a sensor module for monitoring a laser machining process carried out by the laser machining device may comprise an alignment module as described in this disclosure and a sensor unit, said sensor unit being provided with a second optical input for the process radiation emerging from the alignment module, a coupling element which is coupled to the second coupling device of the alignment module and couples the second optical input to the first optical output of the alignment module, and at least one detector for detecting the process radiation, wherein the alignment module is configured to align a central axis of the second optical input of the sensor unit with process radiation entering the first optical input of the first coupling device. Preferably, the coupling element of the sensor unit is detachably coupled to the second coupling device of the alignment module. Alternatively, the coupling element of the sensor unit may be firmly connected to the second coupling device of the alignment module. The sensor unit may be formed integrally with the alignment module.

According to another aspect of the present disclosure, a laser machining system is provided, comprising: a sensor module described in this disclosure; and a laser machining device for machining a workpiece by means of a laser beam, in particular a laser welding head or a laser cutting head. The laser machining device comprises an optical output for coupling out process radiation, i.e. a so-called process radiation output, and a coupling element coupled to the first coupling device of the alignment module. The laser machining device may include a beam splitter for coupling process radiation out of the beam path of a laser beam.

The laser machining process to be monitored may in particular be a laser welding process. Alternatively, it may be a laser cutting process.

The invention is based on the idea of providing an alignment module between the laser machining device of the laser machining system and the sensor unit for monitoring the laser machining process, thereby making it possible to align the process radiation with a central axis of the optical input of the sensor unit and to adjust a defined focal position of the process radiation. The central axis of the optical input of the sensor unit may also be regarded as the optical axis of the sensor unit. In other words, the focal position and/or alignment of the process radiation coupled out of the laser machining device may be adjusted or aligned to the sensor unit as a whole using the alignment module. As a result, individual detectors of the sensor unit no longer have to be adjusted individually to the process radiation of a respective laser machining device, but may be adjusted in advance, e.g. during production of the sensor unit, to process radiation aligned with the central axis of the optical input of the sensor unit.

When the sensor unit is put into operation on a respective laser machining device, the sensor unit as a whole is then aligned or adjusted to the laser machining device or to the process radiation coupled out of the respective laser machining device using the alignment module. The alignment module can compensate for deviations in the beam path of the process radiation, which are caused, for example, by imaging errors or incorrect settings of the optical components of the laser machining device.

During alignment, the focusing optics in the alignment module may be displaced along the optical axis of the focusing optics and the sensor unit as a whole may be adjusted in angle and/or displaced in one or two directions perpendicular to the optical axis of the focusing optics. The described invention greatly simplifies initial operation since the sensor unit can be aligned as a whole by merely adjusting the angle or displacement and adjustment of the focusing optics in the alignment module because of the calibration during manufacture. The sensor unit as a whole can therefore be adjusted in angle via the alignment module with respect to a beam axis of the process radiation coupled out of the laser machining device and/or displaced in two directions perpendicular to the optical axis.

A further advantage of the invention is faster and reproducible replacement of the sensor unit in the event of a defect or when the laser machining device is retrofit. In these cases, a mounted sensor unit may be separated from the alignment module. The alignment module may remain connected to the laser machining device or remain mounted thereon. The alignment module remains adjusted to the laser machining device. That is, the position of the first coupling device and the second coupling device of the alignment module relative to one another remain unchanged. The setting of the focusing optics also remains unchanged. That is, the focal position and alignment of the process radiation in relation to the central axis of the optical output of the alignment module do not change. Another sensor unit may then be connected to the alignment module. Since the alignment module is already adjusted to the laser machining device and remains in this setting and the new sensor unit is also adjusted and/or calibrated during manufacture, no further adjustment or calibration steps are necessary when replacing the sensor unit. When the new sensor unit is connected to the alignment module, the process radiation is already aligned with the central axis of the optical input of the sensor unit. Moreover, the measurement signals emitted by the new sensor unit are comparable with the previously mounted sensor unit. This is because differences between two sensor units may be compensated for by a manufacturer-side calibration of each sensor unit and measurement signals output by two sensor units may be compared with one another. Thus, after calibration, two sensor units may have the same measurement signal strengths at the same incoming light intensity.

The alignment module may be configured to adjust at least one angle and/or an offset between the central axis of the first optical input and the central axis of the first optical output. The alignment module may be configured to shift the central axis of the first optical output in at least one direction perpendicular to the central axis of the first optical input, preferably in two mutually perpendicular directions perpendicular to the central axis of the first optical input. Alternatively or additionally, the first adjustment module of the alignment module may be configured to adjust at least one angle between an optical axis or central axis of the first optical output and the optical axis or central axis of the first optical input and/or to adjust an offset between the optical axis or central axis of the first optical output and the optical axis or central axis of the first optical input and/or to displace the central axis of the optical output in at least one direction in a plane perpendicular to the central axis of the first optical input. The offset may denote a distance or a displacement of the two central axes relative to one another in a plane perpendicular to one or both central axes themselves. The at least one angle may be two angles, in particular two solid angles, between the central axis of the first optical input and the central axis of the first optical output. Thus, by adjusting the angle and/or the offset of the central axis of the output with respect to the central axis of the input, an alignment of the process radiation with respect to the sensor unit connected to the output of the alignment module may be adjusted at the same time. As a result, the process radiation may enter the sensor unit with a defined alignment. An alignment of the process radiation includes both an angle and an offset of the process radiation to a central axis of the second optical input or to an optical axis of the sensor unit.

The first adjustment module may be configured to be operated automatically and/or manually. Manual operation includes operation by the hand of a user of the alignment module. Alternatively, the first adjustment module may be operated automatically, for example by a controller. The first adjustment module may be configured for a linear movement of the second coupling device with respect to the first coupling device in the at least one direction. The first adjustment module may include at least one of a linear motor, a linear guide, a piezoelectric element, and a micrometer screw. The first adjustment module may be configured for a tilting or pivoting movement of the second coupling device with respect to the first coupling device about at least one tilting or pivoting axis perpendicular to the central axis of the first optical input or to the optical axis of the focusing optics. The first adjustment module may comprise a ball joint. The first coupling device may be connected to the joint socket of the ball joint or may be formed integrally therewith and/or the second coupling device may be connected to the joint socket of the ball joint or may be formed integrally therewith. According to an alternative embodiment, the second coupling device may be connected to the joint socket of the ball joint or may be formed integrally therewith and/or the second coupling device may be connected to the joint socket of the ball joint or may be formed integrally therewith.

The focusing optics can be displaceable in parallel to or along a central axis of the first optical input of the alignment module and/or in parallel to or along a central axis of the first optical output of the alignment module. A focal position of the process radiation may thereby be adjusted. The process radiation may thus enter the sensor unit with a defined focal position and/or have a predetermined focus.

The alignment module may further include a second adjustment module for adjusting the displacement of the focusing optics. The second adjustment module may include a holder for holding the focusing optics and/or a guide element, such as a rail for guiding the holder. The rail may be configured to guide the holder and thus also the focusing optics along the central axis of the optical input and/or along the central axis of the optical output. The rail may be firmly connected to the first coupling device or the coupling element of the first coupling device and/or the second coupling device or the coupling element of the second coupling device and/or may be formed integrally. The holder may be annular or cylindrical. The focusing optics may include a lens, a lens group or one or more other optical elements for focusing the process radiation.

The first coupling device and/or the second coupling device may comprise a coupling element, for example a flange.

The at least one detector may be configured to detect at least one beam parameter of the process radiation, in particular an intensity in a specific wavelength range. The at least one detector may further be configured to output a detection signal.

The sensor unit can comprise a number of detectors, each of which is configured to detect the process radiation at different wavelengths. Furthermore, the sensor unit may include a plurality of beam splitters, each of which is configured to couple a partial beam out of the process radiation and direct it onto a detector. The beam splitters may comprise partially transparent mirrors.

One or more beam splitters may be provided to split the process radiation onto a plurality of detectors. The beam splitters may be configured to couple out the partial beams in a wavelength-selective manner. The beam splitters may have a wavelength selective coating, such as a dichroic coating. In particular, the beam splitters may each have different wavelength-selective coatings. As a result, a partial beam with a specific wavelength or with a specific wavelength range is coupled out from each beam splitter. Thereby, an optimal or improved light yield can be achieved in the respective wavelength range for the respective detectors.

The detectors may comprise a photodiode and/or a photodiode array and/or a camera, for example a CMOS or CCD-based camera.

The respective detectors may only be sensitive at a specific wavelength or in a specific wavelength range. For example, a first detector may be sensitive in the visible range of the light spectrum, a second detector may be sensitive in a laser emission wavelength range of the laser machining device, and/or a third detector may be sensitive in an infrared range of light. The detectors may therefore be configured such that they are sensitive in different wavelength ranges. According to an embodiment, the sensor unit comprises a diode sensitive in the visible spectrum of light in order to detect plasma process emissions, a diode sensitive in the range of the laser emission wavelength in order to detect reflections of the laser of the laser machining device, and a diode sensitive in the infrared wavelength range in order to detect process emissions in the infrared or temperature spectral range.

The sensor unit may also comprise a control unit. The control unit may be configured to receive analog measurement signals from the at least one detector. Furthermore, the control unit may be configured to convert the analog measurement signals into digital measurement signals in order to forward them to an external control unit.

The measurement signal from a detector can be a single measurement value, a list of measurement values, or a continuously output signal. The measurement signal may in particular be an analog signal. For example, the detectors may be configured to output a voltage signal.

The sensor unit or the control unit may also include an interface to output or forward the digital measurement signals. The interface may be configured to transmit the digital measurement signals to the outside, for example to a superordinate control unit. For example, the interface may be configured to forward the digital measurement signals to a control unit of the laser machining device and/or a control unit of the laser machining equipment, in particular an equipment controller. The interface may be described as a “digital front end”. An advantage of this embodiment is an improved signal-to-noise ratio of the measurement signals in comparison to signals after analog signal transmission and a lower susceptibility to external interference from electromagnetic radiation.

Each of the at least one detector may be calibrated for rays along the central axis of the optical input of the sensor unit. Each of the at least one detector may also be configured to be displaceable in a plane perpendicular to its optical axis. In other words, the position of the detector may be adjustable in a plane perpendicular to its optical axis, i.e. in two spatial directions. The two spatial directions may be, for example, perpendicular to a beam axis of the partial beam incident on the detector. For the adjustment, the sensor unit may have a corresponding number of adjustment devices. The adjustment devices may each comprise a piezoelectric element and/or a micrometer screw. The adjustability of the detectors makes it possible to set or adjust each of the detectors to a beam axis of the partial beams. The adjustment makes it possible for the partial beams to hit the detectors in an optimal manner, in particular centered on a detector surface of the detectors. The adjustment maybe performed, for example, during the manufacture of the sensor unit.

When the sensor unit is put into operation, the sensor unit may then be adjusted by means of the alignment module in such a way that the process radiation coupled out from a laser machining device enters or is coupled into the sensor unit with the same defined or specified focal position and/or alignment as during the adjustment of the detectors. Since the detectors have already been adjusted accordingly in advance, it is no longer necessary to adjust the detectors for initial operation. In other words, the adjustment of the detectors can be anticipated at the factory.

The sensor unit may be calibrated before it is put into operation, for example during manufacture. The calibration may be performed by means of reference radiation or a reference beam, with the reference radiation originating, for example, from a reference light source with defined light intensity. In particular, the at least one detector of the sensor unit may be calibrated using a light source that can be measured in absolute terms. The reference radiation may enter or be coupled into the sensor unit with a defined or predetermined alignment, the alignment preferably being such that the reference radiation is aligned with the central axis of the optical input of the sensor unit. Furthermore, the reference radiation may be coupled into the sensor unit with a defined or predetermined focal position. The sensor unit may be configured such that, in the defined or predetermined focal position of the reference radiation, the focus of the reference radiation coincides with a surface of each of the at least one detector. The measurement signals output by the detectors during this factory calibration may be stored by the control unit as reference values. Furthermore, the control unit may be configured to generate and store calibration values based on the output measurement signals. The detectors may also be adjusted with respect to the reference radiation, as described above.

The measurement signals output after the sensor unit has been put into operation on a laser machining device at the customer may thus be output with respect to or in relation to these reference values.

The described alignment of the respective sensor unit by means of the alignment module on a respective laser machining device in conjunction with the factory adjustment and calibration using a reference light source can thus ensure that the output measurement signal strengths of sensor units of different laser machining systems with regard to this reference light source are comparable or ideally identical.

As a result of the described adjustment and calibration of the sensor unit during manufacture, the sensor unit no longer has to be adjusted and calibrated on site and before it is put into operation with a specific laser machining device. The sensor unit can therefore be viewed as a closed system.

With the sensor unit, measurement signals of the beam parameters of the process radiation may be acquired and optionally also analyzed. This allows conclusions to be drawn about various process parameters of the laser machining process. For example, software may evaluate the measurement signals and output a result of this evaluation for each workpiece or component machined by the laser machining device, for example

“OK” or “Not OK”. Typically, the software must be parameterized very precisely for this purpose. For example, certain upper or lower limits for the measurement signal strength or limits for the fluctuations in the measurement signals must be defined, with which the categorization into “OK” and “Not OK” is carried out. Since the signals are comparable due to the calibration of the sensor unit on different laser machining systems, it is possible to transfer well-adjusted software or parameterization thereof from one laser machining equipment to a variety of other laser machining equipment and to guarantee reliable monitoring for each equipment.

### BRIEF DESCRIPTION OF THE DRAWINGS

The invention is described in detail below with reference to figures. In the figures;

FIG. 1 shows a schematic diagram of a laser machining system for machining a workpiece by means of a laser beam according to embodiments of the present disclosure;

FIG. 2 shows a schematic diagram of a sensor module for a laser machining system for monitoring a laser machining process according to embodiments of the present disclosure; and

FIG. 3 is a schematic diagram of an alignment module for coupling a sensor unit to a laser machining device for monitoring a laser machining process according to embodiments of the present disclosure.

### DETAILED DESCRIPTION OF THE DRAWINGS

Unless otherwise noted, the same reference symbols are used for identical and equivalent elements below.

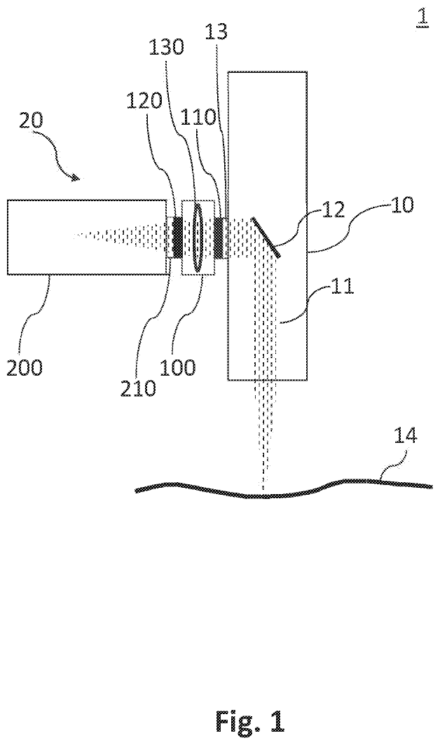

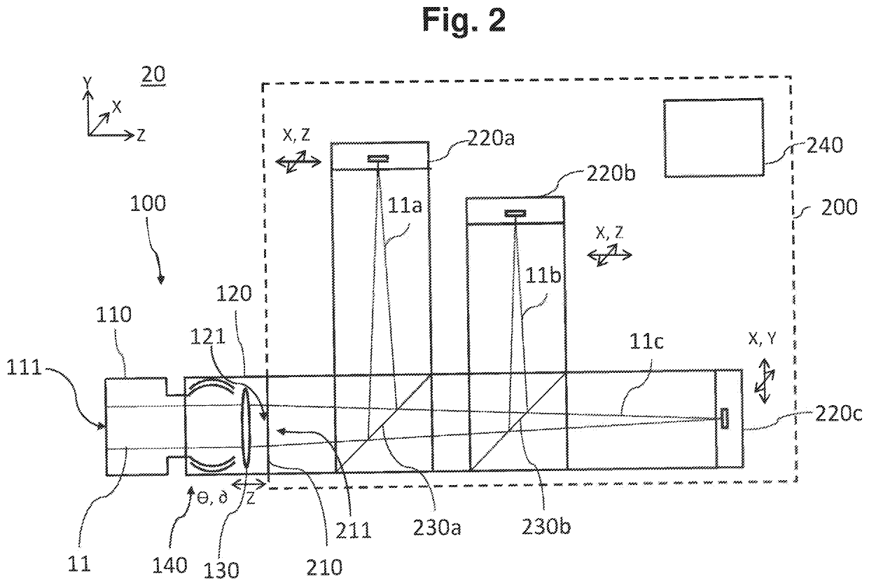

FIG. 1 shows a schematic diagram of a laser machining system for machining a workpiece by means of a laser beam according to embodiments of the present disclosure. FIG. 2 shows a schematic diagram of a sensor module for a laser machining system for monitoring a laser machining process according to embodiments of the present disclosure.

The laser machining system 1 comprises a laser machining device 10 and a sensor module 20.

The laser machining device 10, which may be configured as a laser machining head, for example, is configured to focus or collimate a laser beam (not shown) emerging from a laser light source or an end of a laser optical fiber onto a workpiece 14 to be machined using a beam guiding and focusing optics (not shown) to thereby perform machining or machining process. Machining may comprise laser cutting, soldering or welding, for example.

During machining, process radiation 11 is created which enters laser machining device 10 and is coupled out of a beam path of the laser beam (not shown) by a beam splitter 12. The laser machining device 10 includes a coupling element 13 and an optical output (not shown). The optical output or process radiation output may be combined with the coupling element 13. The process radiation 11 is coupled out of the process radiation output of the laser machining device 10.

The sensor module 20 comprises an alignment module 100 and a sensor unit 200.

The alignment module 100 includes a first coupling device 110 and a second coupling device 120. The first coupling device 110 includes a coupling element (not shown) and a first optical input 111. The second coupling device 120 includes a further coupling element (not shown) and a first optical output 121. Furthermore, the alignment module 100 includes a focusing optics 130 displaceable along its optical axis in order to adjust a focal position.

The sensor unit 200 typically includes a plurality of detectors or sensors 220 which are configured to detect various parameters of the process radiation 11 such as an intensity and to output a measurement signal based on the detection. The sensor unit 200 also includes a coupling element 210 and a second optical input 211. The second optical input 211 may be formed in combination with the coupling element 210.

The coupling element of the first coupling device 110 is connected to the coupling element of the laser machining device 10. Thus, the alignment module 100 is coupled to the laser machining device 10. In other words, the process radiation output of the laser machining device 10 is coupled to the first optical input 111 of the alignment module 100.

The coupling element of the second coupling device 120 is connected to the coupling element 210 of the sensor unit 200. Thus, the alignment module 100 is coupled to the sensor unit 200. In other words, the first optical output 121 of the alignment module 100 is coupled to the second optical input of the sensor unit 200.

Thus, the sensor unit 200 is coupled to the laser machining device 10 via the alignment module 100. Here, the alignment module 100 has the function of an adapter. In the state shown in FIG. 1, the process light 11 emerging from the process radiation output of the laser machining device 10 is incident on the first optical input 111 of the alignment module 100. It then emerges from the first optical output 121 of the alignment module 100 and enters the second optical input 211 of the sensor unit 200. In the sensor unit 200, it hits the at least one detector 220.

The alignment module 100 includes a focusing optics 130 arranged in the beam path of the process radiation 11 between the first optical input 111 and the second optical output 121 of the alignment module 100. Furthermore, the alignment module 100 includes a first adjustment module 140 arranged between the first coupling device 110 and the second coupling device 120. The first adjustment module 140 is configured to tilt the first coupling device 110 and the second coupling device 120 relative to one another or to displace them relative to one another in at least one direction. As a result, the first optical input 111 and the first optical output 121 of the alignment module 100 are also tilted or displaced relative to one another. This in turn leads to the alignment of the process radiation 11 in relation to the first optical output 121 of the alignment module 100 and to the second optical input 211 of the sensor unit 200 being changed.

As a result, the process radiation 11 may be adjusted with respect to a central axis of the second optical input 211 of the sensor unit 200, for example. In particular, the process radiation 11 may be aligned with the central axis of the second optical input 211. In other words, it may extend in parallel to a central axis of the optical input 211.

By means of the focusing optics 130 of the alignment module 100, the process radiation 11 may also be focused or a defined or predetermined focal position may be set.

As shown in FIG. 2, the first adjustment module 140 may comprise a ball joint. The joint socket of the ball joint is connected to the first coupling device 110. According to embodiments, the joint socket of the ball joint and the first coupling device 110 are formed integrally. The joint socket of the ball joint is connected to the second coupling device 120. According to embodiments, the joint socket of the ball joint and the second coupling device 120 are formed integrally.

The ball joint allows an orientation or alignment of the second coupling device 120 with respect to the first coupling device 110 to be adjusted. The alignment may be carried out in two spatial directions or spatial angles θ, ∂.

As shown in FIG. 2, the focusing optics 130 may include a focusing lens. The focusing lens is displaceable or adjustable along or in parallel to a Z direction. According to embodiments, the Z direction corresponds to an optical axis of the focusing optics 130. The optical axis of the focusing optics 130 may correspond to a central axis of the first coupling device 110 or the first optical input 111 or a central axis of the second coupling device 120 or the first optical output 121.

As shown in FIG. 2, the sensor unit 120 comprises a plurality of detectors 220a, 220b, 220c. Each of the detectors 220a, 220b, 220c may comprise a photodiode or a photodiode array or pixel array.

Furthermore, the sensor unit 200 comprises a plurality of beam splitters 230a, 230b to split up or divide the process radiation 11. As shown in FIG. 2, the beam splitters 230a, 230b may configured as partially transparent mirrors. The beam splitters 230a, 230b are each configured to couple at least one partial beam 11a, 11b, 11c out of the process radiation 11. As shown in FIG. 2, the beam splitter 230a couples the partial beam 11a, which hits the detector 220a, out of the process radiation 11. The beam splitter 230b couples the partial beams 11b and 11c out of the process radiation 11, the partial beam 11b hitting the detector 220b and the partial beam 11c hitting the detector 220c.

According to embodiments, the beam splitters 230a, 230b may be wavelength selective. In other words, the beam splitters 230a, 230b may couple the partial beams 11a, 11b, 11c out of the process radiation 11 in a wavelength-selective manner. For example, the beam splitter 230a may be configured to couple out light in the visible spectrum as a partial beam 11a and the beam splitter 230b may be configured to couple out light in the infrared spectrum as a partial beam 11b. In this case, the partial beam 11c may contain light which has a wavelength range of the laser beam of the laser machining device 10. As a result, an improved or optimal light yield may be obtained by the respective detector 220a, 220b, 220c since only light with a specific wavelength or wavelength range hits the respective detector 220a, 220b, 220c.

The detectors 220a, 220b, 220c are configured to detect the respective impinging partial beam 11a, 11b, 11c. The detectors 220a, 220b, 220c are configured, in particular, to detect a parameter of the respective partial beam 11a, 11b, 11c. In particular, the detectors 220a, 220b, 220c may be configured to detect an intensity of the respective partial beam 11a, 11b, 11c. The detectors 220a, 220b, 220c are configured to generate and output a measurement signal based on the detection. The measurement signal may be an analog voltage signal, for example.

The sensor unit 200 also comprises a control unit 240. The control unit 240 is connected to the detectors 220a, 220b, 220c and receives the measurement signals from the detectors 220a, 220b, 220c. The control unit 240 is configured to convert the analog measurement signals into digital measurement signals and to provide the digital measurement signals at an interface (not shown).

The detectors 220a, 220b, 220c are arranged in the beam path of the respective partial beams 11a, 11b, 11c such that a focal position or focal point of the partial beams 11a, 11b, 11c coincides with a surface of the detectors 220a, 220b, 220c. In other words, the detectors 220a, 220b, 220c are arranged such that, for a process radiation 11 coupled into the sensor unit 200 with a predetermined alignment and a predetermined focal position, the position of the detectors 220a, 220b, 220c coincides with the focal point of the respective partial beams 11a, 11b , 11c. In particular, the partial beams 11a, 11b, 11c may have the same optical path length between the optical input 211 of the sensor unit 200 and the respective detector 220a, 220b, 220c.

As described above, the predetermined alignment of the process radiation 11 may be such that the process radiation 11 is aligned with a central axis of the optical input 211 of the sensor unit 200 or extends in parallel or coaxially thereto.

As shown in FIG. 2, the detectors 220a, 220b, 220c can each be adjusted in two directions. That is, the position of the detectors 220a, 220b, 220c can be adjusted in two directions. For example, the two directions may each be perpendicular to a beam axis of the partial beams 11a, 11b, 11c. In particular, the detector 220a can be displaced in a plane perpendicular to the beam axis of the partial beam 11a, the detector 220b can be displaced in a plane perpendicular to the beam axis of the partial beam 11b, and the detector 220c can be displaced in a plane perpendicular to the beam axis of the partial beam 11c. As shown in FIG. 2, the detector 220a may be displaced in the X, Z directions with the partial beam 11a extending in parallel to the Y direction, the detector 220b can be displaced in the X, Z directions with the partial beam 11b extending in parallel to the Y direction, and the detector 200c can be displaces in the directions X, Y with the partial beam 11c extending in parallel to the Z direction. The X, Y and Z directions may correspond to coordinate axes of a Cartesian coordinate system, the Z direction being chosen along the optical axis of the focusing optics 130 in this example. The described adjustability of the detectors 220a, 220b, 220c makes it possible to set or adjust each of the detectors to a beam axis of the partial beams 11a, 11b, 11c. The adjustment may be performed during the production of the sensor unit 200, for example. The adjustment makes it possible for the partial beams 11a, 11b, 11c to hit the detectors 220a, 220b, 220c in an optimal manner, in particular centered on a detector surface of the detectors 220a, 220b, 220c.

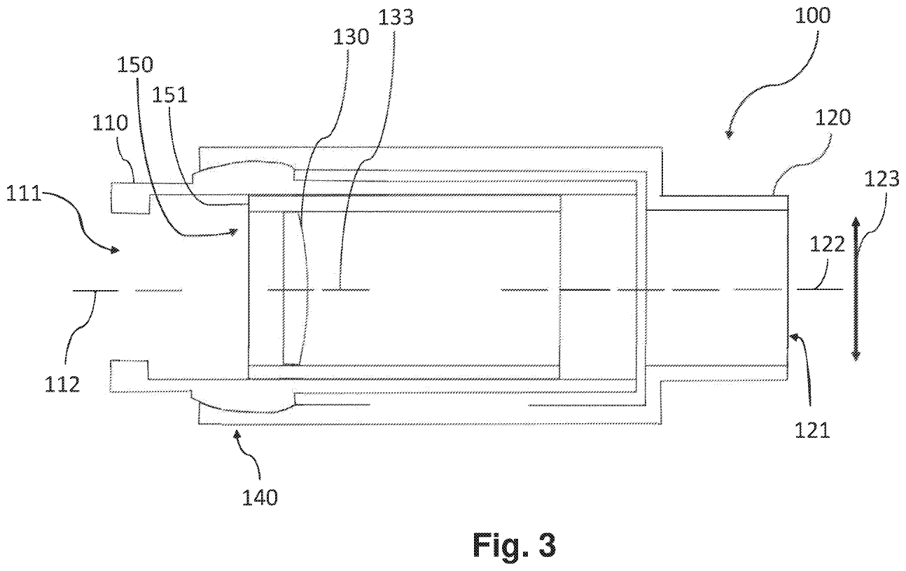

FIG. 3 shows a schematic diagram of an alignment module for coupling a sensor unit to a laser machining device for monitoring a laser machining process according to other embodiments of the present disclosure.

The embodiment of the alignment module 100 shown in FIG. 3 includes a first coupling device 110, a second coupling device 120, a first adjustment module 140 and a focusing optics 130.

The first coupling device 110 comprises an optical input 111 with a central axis 112. The second coupling device 120 comprises an optical output 121 with a central axis 122.

The first adjustment module 140 corresponds to the embodiment shown in FIG. 2, and a description thereof is omitted.

The focusing optics 130 is configured as a focusing lens. The alignment module 100 further includes a second adjustment module 150. The adjustment module 150 includes a holder 151 holding the focusing optics 130. The focusing optics 130 has an optical axis 133. As shown in FIG. 3, the optical axis 133 extends coaxially or in parallel to the central axis 112 of the first optical input 111. According to other embodiments, the optical axis 133 may extend coaxially or in parallel to the central axis 122 of the first optical output 121.

The focusing optics 130 is displaceable along the optical axis 133 of the focusing optics 130 using the holder 151. The focusing optics 130 may further comprise a guide element (not shown), for example a rail, for guiding the holder 132 along the optical axis 133. According to embodiments, the lens 130 may also be displaceable along or in parallel to the central axis 112 of the optical input 111.

As shown in FIG. 3, the holder 151 is slidably connected to the first coupler 110. The guide element may be formed integrally with the first coupling device 110.

The second coupling device 120 is pivotable or tiltable along the direction 123 with respect to the first coupling device 110 using the first adjustment module 140, which may be configured as a ball joint. The second coupling device 120 may further be pivotable or tiltable along a second direction (not shown) with respect to the first coupling device 110. By tilting the second coupling device 120, the process radiation (not shown in FIG. 3), which enters the alignment module 100 at an angle relative to the central axis 112 of the optical input 111, may be aligned with the central axis 122 of the optical output 122 of the second coupling device 120. The process radiation may thus emerge from the alignment module 100 coaxially or in parallel to the central axis 122 of the optical output 121. As a result, in turn, the process radiation has a defined alignment when entering the second optical input of the sensor unit connected to the alignment module 100 (not shown in FIG. 3). In particular, the process radiation may be aligned with the central axis of the second optical input of the sensor unit.

The alignment module provided between an optical output of the laser machining device and an optical input of the sensor unit makes it possible to align the process radiation with a central axis of the optical input of the sensor unit and to set a defined focal position of the process radiation. In other words, the sensor unit as a whole can be adjusted or aligned to the focus position and/or alignment of the process radiation coupled out by the laser machining device. As a result, individual detectors of the sensor unit no longer have to be individually adjusted to the process radiation of a respective laser machining device, but can be adjusted in advance, e.g. during manufacture of the sensor unit, to process radiation aligned with the central axis of the optical input of the sensor unit. This also allows for factory calibration of the detectors to a reference light source.

1. An alignment module for coupling a sensor unit to a laser machining device for monitoring a laser machining process, said alignment module comprising:
a first coupling device for coupling to said laser machining device, said first coupling device including a first optical input for a process radiation coupled out of said laser machining device;
a second coupling device for coupling to said sensor unit, said second coupling device including a first optical output for the process radiation;
a first adjustment module, which is arranged between said first coupling device and said second coupling device and is configured to tilt said second coupling device relative to said first coupling device and/or displace said second coupling device in at least one direction perpendicular to a central axis of said first optical input; and
a focusing optics which is arranged between said first optical input and said first optical output and is displaceable along an optical axis of said focusing optics.

2. The alignment module according to claim 1, wherein said first adjustment module is configured to adjust an angle and/or an offset between the central axis of said first optical input and a central axis of said first optical output.

3. The alignment module according to claim 1, wherein said first adjustment module comprises a ball joint, a linear guide, a piezoelectric element and/or a micrometer screw.

4. The alignment module according to claim 1, wherein said focusing optics is displaceable along the central axis of said first optical input or along the central axis of said first optical output.

5. The alignment module according to claim 1, further comprising a second adjustment module for adjusting a position of said focusing optics, wherein said second adjustment module includes a holder of said focusing optics and a guide element with which said holder is coupled so as to be slidable along the optical axis of said focusing optics.

6. The alignment module according to claim 5, wherein the guide element is fixedly connected to said first coupling device or fixedly connected to said second coupling device.

7. A sensor module for a laser machining system for monitoring a laser machining process, said sensor module comprising:
an alignment module according to claim 1; and
a sensor unit including a second optical input for the process radiation emerging from said alignment module, a coupling element which is coupled to said second coupling device of said alignment module and couples said second optical input to said first optical output of said alignment unit, and at least one detector for detecting the process radiation,
wherein said alignment module is configured to align a central axis of said second optical input of said sensor unit to a process radiation entering said first optical input of said first coupling device.

8. The sensor module according to claim 7, wherein said sensor unit comprises a detector arranged on the central axis of said second optical input.

9. The sensor module according to claim 8, wherein said sensor unit further comprises:
at least one further detector arranged at a distance from the central axis of said second optical input; and
at least one beam splitter which is arranged on the central axis of said second optical input an is configured to couple a partial beam out of the process radiation and to direct it to said further detector.

10. The sensor module according to claim 9, wherein the detectors are each configured to detect different wavelengths of the process radiation, and/or
wherein said beam splitter is configured to reflect or transmit partial beams with a specific wavelength.

11. The sensor module according to claim 7, wherein the at least one detector of said sensor unit is calibrated for rays along the central axis of said second optical input of said sensor unit.

12. The sensor module according to claim 7, wherein said sensor unit further comprises:
a control unit configured to receive analog measurement signals from the at least one detector and convert them into digital measurement signals.

13. The sensor module according to claim 7, wherein said sensor unit is detachably attached to said alignment module or is formed integrally with said alignment module.

14. A laser machining system, comprising:
a sensor module according to claim 7; and
a laser machining device for machining a workpiece by a laser beam, said laser machining device including a process radiation output and a coupling element which is coupled to said first coupling device of said alignment module and couples the process radiation output of said laser machining device to said first optical input of said alignment module unit.

15. The laser machining system according to claim 14, wherein said laser machining device further comprises a beam splitter for coupling process radiation out of the beam path of the laser beam of said laser machining device.
